(19) United States
(12) Patent Application Publication
(10) Pub. No.: US 2017/0278088 A1
(43) Pub. Date: Sep. 28, 2017

(54) MOBILE PAYMENT ASSISTANT FOR GAS TRANSACTIONS

(71) Applicants: Ann Vixamar, Aventura, FL (US); Fernando Carmona Rivera, Aventura, FL (US)

(72) Inventors: Ann Vixamar, Aventura, FL (US); Fernando Carmona Rivera, Aventura, FL (US)

(21) Appl. No.: 15/080,820

(22) Filed: Mar. 25, 2016

(51) Int. Cl. G06Q 20/32; G06Q 20/10

(52) U.S. Cl. CPC G06Q 20/322; G06Q 20/102

(57) ABSTRACT

A mobile payment system for gas purchases including: a user bank account; a gas spending account, where the user bank account funds the gas spending account; a software application adapted for use on a user's portable electronic device, where the software application includes functional instructions related to the mobile payment system; a communications link between the user's portable electronic device and a plurality of gas vendors; a transactional link between the gas spending account and the plurality of gas vendors; and a database, where the database stores transactions related to the gas spending account. The user bank account may include at least one of a checking account, savings account or a credit card account. The communications link may be over a network communications network such as a cellular network.

### BACKGROUND OF THE INVENTION

Field of Invention

The present invention relates to a mobile application to facilitate the gas purchases.

Description of Related Art

Motor vehicles employ all types of energy sources. The most typical and prevalent energy source for motor vehicles remains petroleum in the form of gasoline. Although inroads have been made into electrically power cars, petroleum vehicles are by far the most prevalent vehicle on the road. The typical user of a motor vehicle as a result must purchase gasoline as fuel for their motor vehicle. The typical gas purchase is conducted either at the pump through the use of a user's credit or debit card or alternatively cash may also be used by engaging a sales clerk at a sales counter. Drawbacks to the typical gas purchase and transaction are related to the particular type of purchase transaction. If a user uses their credit card at a gas station, a risk exists that the credit card may be copied through an illegally incorporated card reader. This type of identity theft frequently happens to users without their knowledge. Another source of danger is the leaving of the car unattended in order to make the purchase with a sales clerk. The purchase with a sales clerk reduces the risk of identity theft but however leaves the vehicle exposed to potential petty robberies. Further physical assaults may also occur during the short walk to the sales clerk and back to the individual's vehicle. As a result, it would be advantageous to have a mobile payment system that was engaged in a mobile electronic device to provide a more efficient and secure means to engage in gasoline purchases.

Mobile payment systems are well known in the prior art and presently are engaged in various types of mobile payment transactions via a mobile electronic device such as a Smartphone. The Smartphone capabilities enable the implementation of application that can provide a bar code or other electronic link between a user's mobile payment service and the gas vendor's gas pump.

### SUMMARY OF THE INVENTION

The present invention relates to a mobile payment system for gas purchases including: a user bank account; a gas spending account, where the user bank account funds the gas spending account; a software application adapted for use on a user's portable electronic device, where the software application includes functional instructions related to the mobile payment system; a communications link between the user's portable electronic device and a plurality of gas vendors; a transactional link between the gas spending account and the plurality of gas vendors; and a database, where the database stores transactions related to the gas spending account. The user bank account may include at least one of a checking account, savings account or a credit card account. The communications link may be over a network communications network such as a cellular network.

### BRIEF DESCRIPTION OF DRAWINGS

FIG. 1 depicts an implementation of a mobile gas payment application onto an electronic device.

### DETAILED DESCRIPTION

The present invention relates to a mobile payment system that's implemented for gas transactions. Under this particular invention a mobile payment system is used to set up a prepaid gas vending account. A user may fund this prepaid gas vending account through their bank account. Therefore a link is provided to replenish the gas vending account as necessary. The user bank account may be a checking, savings or existing credit card account. This money is placed into a prepaid gas vending account. This gas vending account is accessed through a mobile application stored on the user's portable electronic device. Preferably the portable electronic device is a Smartphone. The database is compiled through the Smartphone application at a accessible linkage to the application functions on the Smartphone. This database records transaction history purchase amounts gas account availability. Gas vendors are linked to the gas account to receive payment for gas purchases by the user.

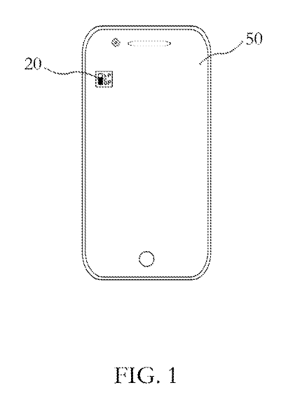

The user may access this gas payment application through a network connection using their portable electronic device. FIG. 1 provides an overview of this arrangement showing a application icon 20 on a portable electronic device 50. Once the application 20 is stored on the portable electronic device 50, the user may set up a user account that includes linkage to the user's bank account to fund the gas payment account. This gas payment account is then available for use on the user's portable electronic device. As a result, the user may establish a wireless link between the user and the gas vendor either upon arrival at the gas vending station or via a communications network link. If desired, the user may initiate a gas purchase prior to the arrival to the gas vendor. If a link is provided upon arrival the gas vendor can provide a linking system in the form of mobile payment equipment. The mobile payment equipment typically reads the wireless application protocol installed on the user's portable electronic device. As a result, the user may then pay for the gas purchase through this wireless connection provided by the gas vendor.

Use of the present invention eliminates the requirement of credit cards or cash payment and further eliminates having to engage with a sales clerk at a gas vending station. The mobile gas payment system could improve and eventually reduce risks associated with gas purchase transactions and therefore provides a convenient and effective way for payment for gasoline. This present invention also allows a user to also maintain a record of gas expenditures and payment history. The instant invention has been shown and described in what it considers to be the most practical and preferred embodiments. It is recognized, however, that departures may be made there from within the scope of the invention and that obvious modifications will occur to a person skilled in the art.

What is claimed is:

1. A mobile payment system for gas purchases comprising:
a. a user bank account;
b. a gas spending account, where the user bank account funds the gas spending account;
c. a software application adapted for use on a user's portable electronic device, where the software application includes functional instructions related to the mobile payment system;
d. a communications link between the user's portable electronic device and a plurality of gas vendors;
e. a transactional link between the gas spending account and the plurality of gas vendors; and
f. a database, where the database stores transactions related to the gas spending account.

2. The mobile payment system for gas purchases according to claim 1, where the user bank account includes at least one of a checking account, savings account and a credit card account.

3. The mobile payment system for gas purchases according to claim 1, where the communications link is over a network communications network.

4. The mobile payment system for gas purchases according to claim 3, where the network communication network is a cellular network available to the user's portable electronic device.

5. The mobile payment system for gas purchases according to claim 3, where the network communication network is a local network available at one of the plurality of gas vendors.

6. The mobile payment system for gas purchases according to claim 1, where the database stores gas spending account balance.

7. The mobile payment system for gas purchases according to claim 6, where the functional instructions includes alerts to the user's electronic device regarding the gas spending account balance.
